(19) United States
(12) Patent Application Publication
(10) Pub. No.: US 2021/0406807 A1
(43) Pub. Date: Dec. 30, 2021

(54) NATIONAL FOOTBALL LEAGUE BONUS

(71) Applicant: RWRF-1 Trust, Kennewick, WA (US)

(72) Inventor: Patrick T Harrison, Kennewick, WA (US)

(73) Assignee: RWRF-1 Trust, Kennewick, WA (US)

(21) Appl. No.: 16/913,511

(22) Filed: Jun. 26, 2020

(51) Int. Cl. G06Q 10/06; A63B 71/00

(52) U.S. Cl. CPC G06Q 10/063118; A63B 2243/007; A63B 71/00; G06Q 10/063112

(57) ABSTRACT

Methods and systems for efficient establishment and operation of a league (e.g., a competition league, an athletic league, a sports league, etc.) are provided. For instance, a bonus league may be established based on a parent league. According to one or more aspects described herein, the bonus league and the parent league may be established and operated to mutually benefit one another via improved resource utilization (e.g., which may include improved management of player resources, shared team branding and merchandizing, shared marketing, shared stadiums, and shared likeness, among several other examples). The described techniques may additionally provide for effective cross-promotion between the bonus league and the parent league, as well as refined systems for testing and evaluating one or more aspects of the parent league (e.g., as the affiliated bonus league may test and evaluate new rules, rule changes, uniforms, game tactics, marketing strategies, etc.).

### CROSS-REFERENCE TO RELATED APPLICATION

This application claims priority to, and the benefit of, U.S. Provisional Application Ser. No. 63/101,067 filed on Apr. 13, 2020, entitled National Football League Bonus (“NFLB”). The entire contents of the foregoing application are hereby incorporated by reference for all purposes.

### BACKGROUND

The following relates generally to competition leagues, and more specifically to establishing a competition league and establishing teams within the competition league.

A league (e.g., a competition league, an athletic league, a sports league, etc.) may generally refer to a collection of teams, people, or groups that combine for a particular purpose (e.g., such as for competition, for mutual cooperation or protection, etc.). For instance, competition leagues such as sports leagues may include a number of individual competitors, or a number of teams each including a group of competitors, that compete against each other in the context of a specific sport, a specific game or objective, etc. Leagues may provide a structure that allows such competition. As an example, a league may be established to provide competition resources, competition schedules, competition rules, and competition rankings, among other examples.

Leagues may be established for various intents and purposes, such as leagues established for local groups of amateur participants through more complex leagues established for national or international competition amongst professional (e.g., paid or otherwise compensated) participants. As such, techniques for establishing and implementing a league may take many factors into consideration such as the scope of the league (e.g., the sport or game), resources available to the league, the demand for involvement in the league, coexistence with other existing leagues, etc. For example, professional sports leagues (e.g., in which at least some participants or athletes are paid for their performance or involvement in the league) may ever seek to increase demand in the sport, increase demand in the league, increase the quantity and quality of participants available to the league, increase operating revenues, etc.

### SUMMARY

A method for establishing a competition league are described. Embodiments of the method may identify an initial roster for a first team, wherein the first team competes in a first athletic league, evaluate players on the initial roster, select a final roster for the first team based on the initial roster and the evaluation, and select a bonus roster for a second team affiliated with the first team, wherein the bonus roster comprises players that are not selected for the final roster, and wherein the second team competes in a second athletic league.

A method for establishing a competition league are described. Embodiments of the method may identify a first set of teams that competes in a first athletic league that is affiliated with the second athletic league, identify a second set of teams to compete in the second athletic league, wherein each team in the second set of teams uses a team branding of a respective team in the first set of teams, and select a bonus roster for each team in the second set of teams, wherein the bonus roster for each team in the second set of teams comprises players that are not selected for a final roster for the respective team in the first set of teams.

### BRIEF DESCRIPTION OF THE DRAWINGS

FIGS. 1 through 3 show examples of bonus league systems according to aspects of the present disclosure.

FIGS. 4 through 5 show examples of bonus league affiliation diagrams according to aspects of the present disclosure.

FIG. 6 shows an example of a system for establishing a competition league according to aspects of the present disclosure.

FIG. 7 shows an example of a process for establishing a team roster for a competition league according to aspects of the present disclosure.

FIG. 8 shows an example of a process for establishing a competition league according to aspects of the present disclosure.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

As described herein, leagues may be established for various intents and purposes, and thus techniques for establishing and implementing a league may take different factors into consideration. In some cases, competition leagues may be established for local groups of amateur participants (e.g., for recreational leagues, for youth leagues, etc.). In such cases, competition leagues may be designed to support youth development, to provide a fun recreational environment, to coordinate scheduling, to provide competition opportunities within schools (e.g., across local high schools) and workgroups, etc. Such competition leagues may be established to consider student schedules or work schedules, to maintain relatively low costs to participants, to build school-place or work-place comradery, etc.

In other cases, more complex competition leagues may be established for national or international competition amongst professional (e.g., paid or otherwise compensated) participants. Establishment and operation of such competition leagues may be associated with unique considerations and challenges. For instance, professional sports leagues (e.g., in which at least some participants or athletes are paid for their performance or involvement in the league) may ever seek to become increasingly more competitive, increase national or global desire to participate in the sport, acquire or attract world-class athletes to the sport, increase participant or athlete compensation, and so on.

In other words, some competition leagues (e.g., professional sports leagues more so than recreational leagues) may generally desire effective techniques for growth of both the sport and the league. Specifically, competition leagues may desire techniques for increasing public demand and league revenues in order to increase athlete compensation, to increase profits for individuals or groups in ownership of the league, etc. For instance, increasing athlete compensation over time may facilitate attracting future world-class athletes compared to other competition leagues, which may benefit the long-term outlook of the league and competition of the sport in general. In addition to techniques for increasing demand and revenues, improved techniques for protecting, managing, and leveraging league resources may also be desired (e.g., such as improved techniques for protecting and managing athletes or other human resources, improved techniques for leveraging league facilities, improved techniques for leveraging efficient league processes, etc.).

Accordingly, the techniques described herein may provide for efficient establishment and operation of a league (e.g., a competition league, an athletic league, a sports league, etc.). For instance, a bonus league (e.g., a developmental league) may be established based on a parent league (e.g., an existing league, a professional league). According to one or more aspects described herein, the parent league and the affiliated bonus league may be established and operated to mutually benefit one another via improved resource utilization (e.g., which may include improved management of player resources, shared team branding and merchandizing, shared marketing, and shared stadiums, among several other examples described herein). The described techniques may additionally provide for effective cross-promotion between the bonus league and the parent league (e.g., via shared likeness amongst a pair of affiliate teams), as well as refined systems for testing and evaluating one or more aspects of the existing parent league (e.g., as the affiliated bonus league may test and evaluate new rules, rule changes, uniforms, game tactics, marketing strategies, etc.).

Specifically, methods and systems for establishing a league (e.g., a bonus league) and teams within a league (e.g., teams within an existing parent league and teams within a bonus league affiliated with the parent league) are described. Various aspects of shared growth, improved resource utilization, efficient resource sharing, and effective cross-promotion between a bonus league and a parent league are also described with reference to example diagrams and flowcharts.

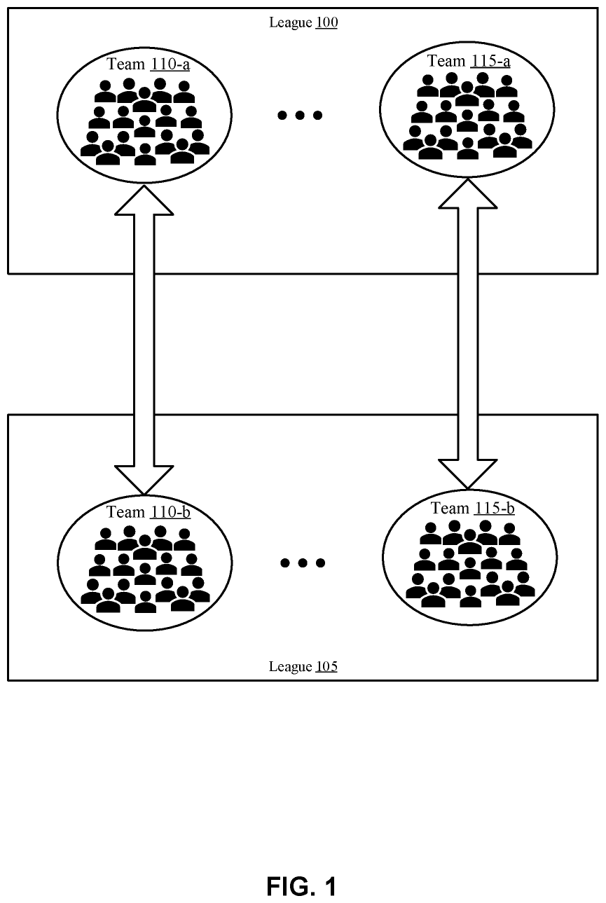

FIG. 1 shows an example of bonus league system according to aspects of the present disclosure. The example shown includes parent league 100 and bonus league 105. In some cases, parent league 100 may be an example of a first league, an existing league, a principal league, a professional league, etc. and bonus league 105 may be an example of a second league, a developmental league, etc. As described in more detail herein, bonus league 105 may be affiliated with parent league 100. Parent league 100 and bonus league 105 may thus include any number of affiliated teams, where the teams in parent league 100 compete amongst each other and the respective affiliate teams in bonus league 105 compete amongst each other.

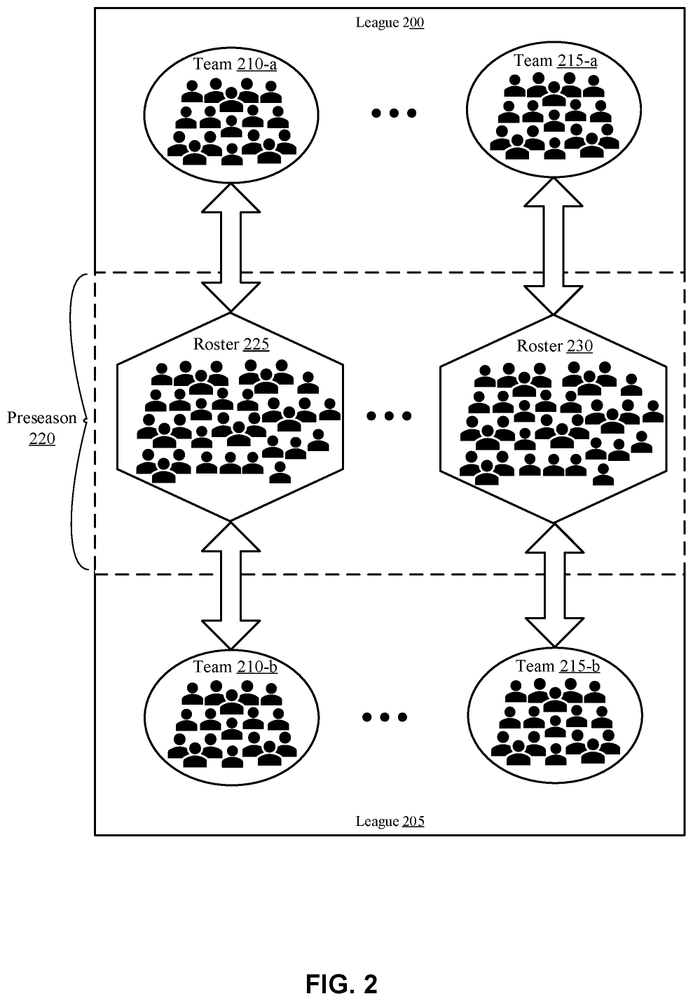

In the example of FIG. 1, parent league 100 may include team 110-a and team 115-a (e.g., which may each be referred to as parent teams), where team 110-a and team 115-a may compete against each other in accordance with parent league 100. Bonus league 105 may include team 110-b (e.g., which may be referred to as a bonus team 110-b affiliated with parent team 110-a) and team 115-b (e.g., which may referred to as a bonus team 115-b affiliated with parent team 115-a). Team 110-b and team 115-b may compete against each other in accordance with bonus league 105. Parent league 100 may be an example of, or include aspects of, parent league 200, 300, and 400 as described with reference to FIGS. 2-4. Bonus league 105 may be an example of, or include aspects of, bonus league 205, 305, and 405 as described with reference to FIGS. 2-4.

As used herein, a league may refer to a competition league, an athletic league, a sports league, or any collection of teams, people, groups, or components that combine for a particular purpose (e.g., such as for competition, for mutual protection or cooperation, etc.). An existing league (e.g., parent league 100) may generally refer to any league established or conceptualized prior to the establishment or the conceptualization of a bonus league (e.g., bonus league 105). A bonus league may generally refer to a league established as an affiliate league to an existing league. Specifically, a bonus league may include one or more competing teams, where each team in the bonus league is affiliated with a respective team in the affiliate existing league (e.g., team 110-b in bonus league 105 may be affiliated with team 110-a in parent league 100 and team 115-b in bonus league 105 may be affiliated with team 115-a in parent league 100). In some cases, a bonus league may be engaged in one or more licensing or branding agreements with the affiliate existing league. Additionally or alternatively, each teach in the bonus league may be engaged in one or more licensing or branding agreements with an affiliate team in the affiliate existing league. In some cases, parent league 100 may be referred to as a parent league to bonus league 105.

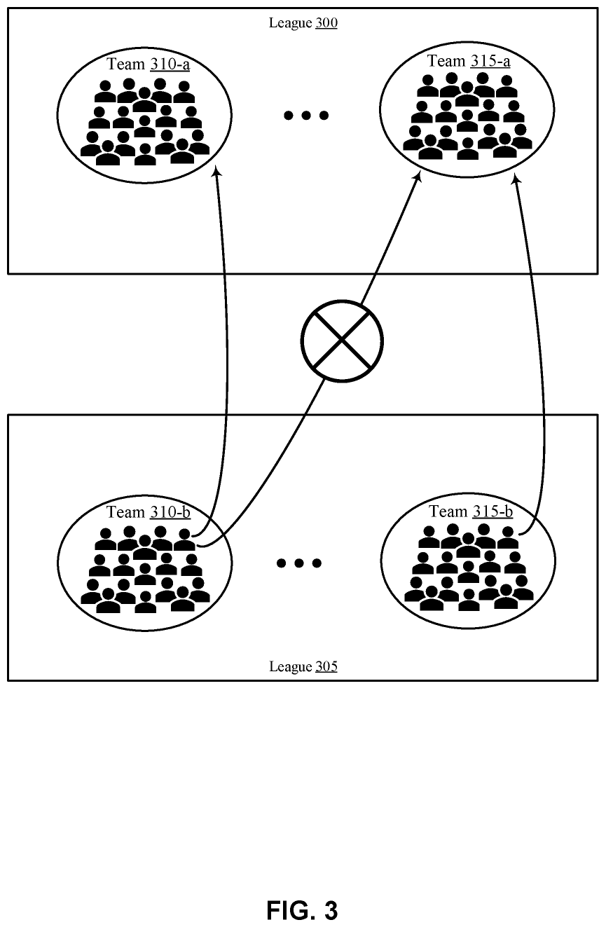

According to one or more aspects described herein, the bonus league and the existing league may be established and operated to mutually benefit one another via improved resource utilization (e.g., which may include improved management of player resources, shared name recognition, shared team branding, shared merchandising, shared marketing, shared stadiums, and shared likeness, among several other examples). For instance, an existing league parent team (e.g., team 110-a in existing parent league 100) and an affiliated bonus team (e.g., team 110-b in bonus league 105) may share player resources (e.g., as further described herein, for example, with reference to FIG. 2). Additionally, a bonus league may improve the depth of a player resource pool for each parent team, as affiliated bonus teams may provide for storage and cultivation of player resources (e.g., as further described herein, for example, with reference to FIGS. 2 and 3). Further, a pair of affiliated teams (e.g., parent team 110-a and bonus team 110-b) may share resources such as athletic facilities (e.g., training facilities, game play stadiums, etc.) and traveling resources (e.g., a pair of affiliated teams may share common traveling schedules, means for transportation, other traveling accommodations, etc.).

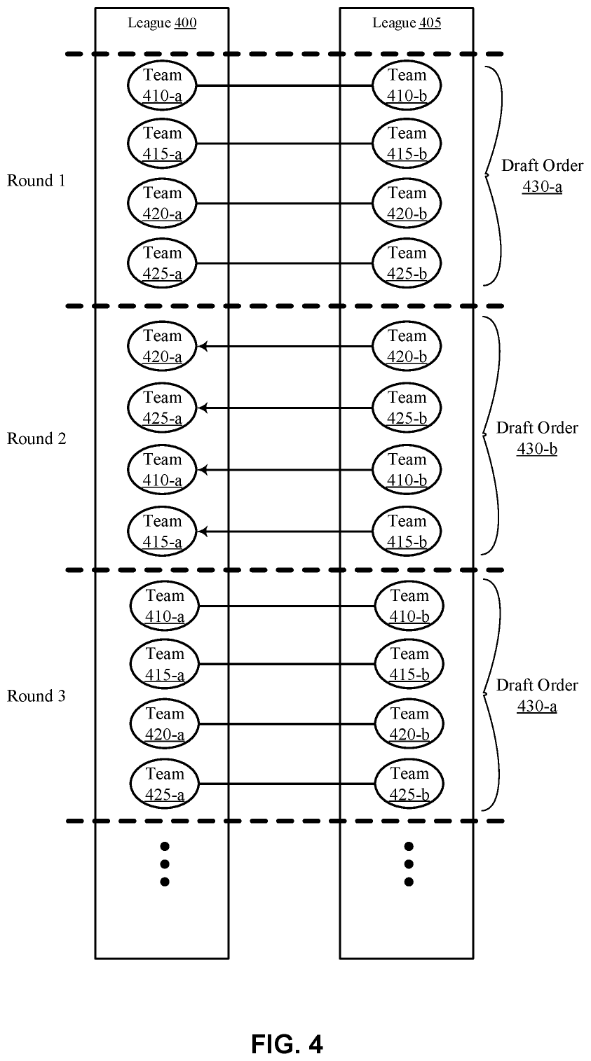

The described techniques may additionally provide for effective cross-promotion between bonus league 105 and parent league 100, as well as refined systems for testing and evaluating one or more aspects of the parent league 100 (e.g., as the associated bonus league 105 may test and evaluate new rules, rule changes, uniforms, game tactics, marketing strategies, etc.). For instance, an existing league (e.g., parent league 100) and a bonus league (e.g., bonus league 105) may be affiliated and may mutually benefit from each other's success. As such, the existing league and the bonus league may promote each other according to one or more of the techniques described herein. As an example, results of the bonus league 105 (e.g., end of season ranking or performance of bonus teams within the bonus league 105) may impact one or more aspects of the parent league 100 such that spectators, fans, or others of interest in a parent team (e.g., team 110-a) may have a vested interest in the success of the bonus team affiliated with the parent team (e.g., team 110-b). In some cases, such may include the results of the bonus league 105 impacting a draft order for the parent league 100 (e.g., as further described herein, for example, with reference to FIG. 4).

In other words, bonus league 105 may be established such that an existing fanbase (e.g., associated with parent team 110-a) may have vested interest in the corresponding pair of affiliate teams (e.g., parent team 110-a and bonus team 110-b). Such interest from an existing fanbase may be developed due to name recognition (e.g., as the pair of affiliate teams may share team branding, such as a team name, team logo, home city, etc.), due to the fact that a bonus team includes developing human resources available to the parent team, due to the fact that the performance of the bonus team within the bonus league 105 directly impacts the affiliated parent team, etc.

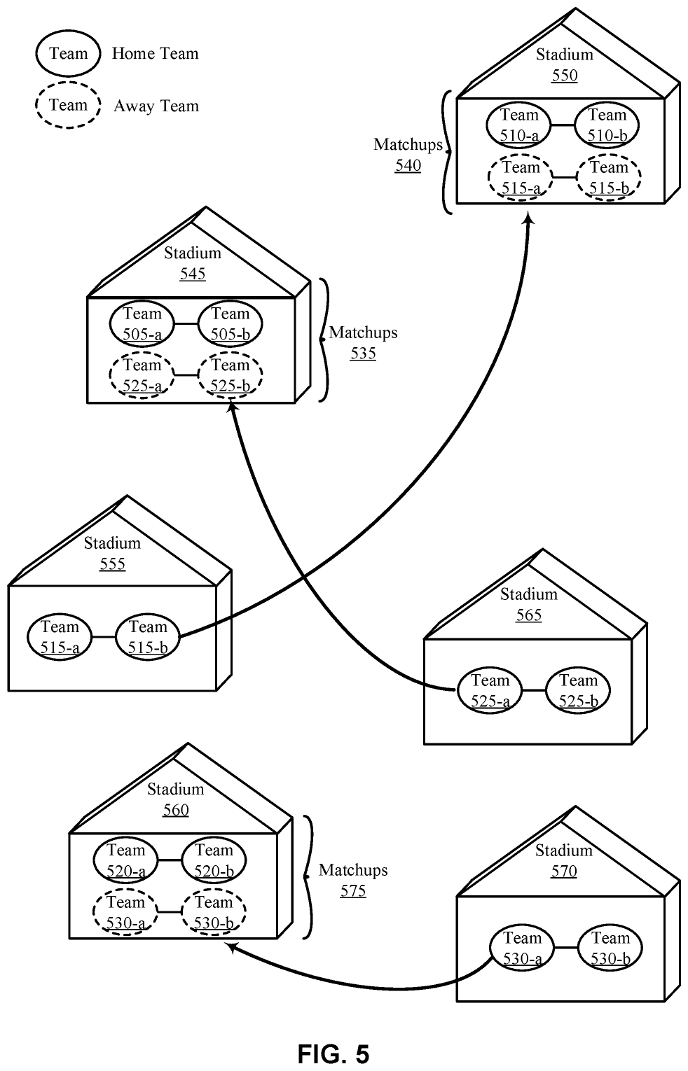

As shown in FIG. 1, a parent league 100 may include any number of parent teams or “A” teams (e.g., such as team 110-a and team 115-a). For establishment of bonus league 105, each parent team may have an affiliated bonus team or “B” team. In other words, bonus league 105 may be affiliated with an existing league (e.g., parent league 100) to establish pairs of affiliate teams across the two leagues. A pair of affiliate teams (e.g., parent team 110-a and bonus team 110-b, parent team 115-a and bonus team 115-b, etc.) may share team branding, resources, etc. For instance, a pair of affiliate teams may share one or more aspects of team branding (e.g., which may include a team name, a team logo, team colors, team uniforms, geographical location), promotional aspects (e.g., marketing, advertising, merchandising), etc. Further, in some examples, a pair of affiliate teams may share facilities (e.g., training facilities, stadiums, etc.) in addition to similar travel and competition schedules (e.g., as further described herein, for example, with reference to FIG. 5).

As an example, parent league 100 may include 32 teams (e.g., 32 parent teams) and bonus league 105 may thus include 32 bonus teams, where each parent team is affiliated with a single bonus team (e.g., in other words, where parent league 100 and bonus league 105 collectively include 32 pairs of affiliate teams). In some examples, the bonus league 105 may serve as a mezzanine (e.g., intermediate, transitional, etc.) level league between the collegiate and the professional arenas (e.g., bonus league 105 may serve as a mezzanine level league between one or more college leagues and a professional parent league 100). As such, bonus league 105 may be specifically designed to retain and develop talented athletes. The bonus league 105 may provide an opportunity for players, coaches, trainers, officials, cheerleaders, etc. to hone skills and augment talent beyond collegiate skills. The bonus league 105 may provide an extra layer of available talent to draw from, which may increase competition for roster spots within parent teams and generally increase competition and skill within the parent league 100.

The bonus league 105 may tap into the branded traditions of the parent league 100, capitalizing on the popularity, history, and nostalgia of the parent league 100. These techniques in addition to other techniques described herein may enable bonus teams and bonus league 105 to efficiently build and recuperate a fan base at a fraction of the cost (e.g., via bonus teams being injected into a same fan base associated with an affiliate parent team, while using similar branding as the affiliate parent team, while having drafting order impact on the affiliate parent team via bonus league 105 season rankings, while curating talent and draft picks of the affiliate parent team, etc.). Offering lower admission costs for the bonus league 105 games may appeal to a wider population. Bonus league 105 may thus provide for additional market expansion of merchandising, television (TV) networks, streaming applications, clothing and apparel, food and beverage, games and gambling, etc., essentially duplicating success of an already reputable parent league 100.

In some examples, bonus teams (e.g., team 110-b and team 115-b) in bonus league 105 may rotate various combinations of new apparel (e.g., uniform) designs for jerseys, helmets, and decals to test popularity of various combinations for respective parent teams in parent league 100. For instance, for each home game, a bonus team may wear various different combinations of jerseys, helmet colors, and decals (e.g., while the visiting bonus team may wear their standard “away” uniforms, which may be the same as the away uniforms that the parent team affiliated with the visiting bonus team wears). If a specific combination of different jerseys, helmet colors, revised decals, etc. catches fan appreciation, there may be an option to replace the affiliated parent team's scheme. As such, bonus teams may wear various apparel or uniforms as a form of a beta-test to see how fans react to a certain uniform change for a pair of affiliate teams.

According to some embodiments, a pair of affiliate teams (e.g., team 110-a and team 110-b, team 115-a and team 115-b, etc.) may be associated with at least similar team branding. In other words, parent team 110-a may be associated with a first team branding that is substantially the same as a second team branding for the affiliate bonus team 110-b. Team branding may generally refer to a team name, a team logo, team colors, a team uniform, a geographic adjective associated with the team name (e.g., ‘Denver,’ ‘Boston,’ ‘New York,’ etc.), among various other examples. According to some examples, differences in branding across one pair of affiliate teams may be consistent across each pair of affiliate teams. That is, differences in branding between a bonus team 110-b and an affiliate parent team 110-a may be analogous or similar to differences in branding between a bonus team 115-b and an affiliate parent team 115-a. Such differences may include a bonus team's variation on an affiliate parent team's name, logo, etc. For instance, for each pair of affiliate teams, the bonus team may include an additional “-B” at the end of the team name of the respective affiliate parent team. In other examples, for each pair of affiliate teams, the bonus teams' logos may be associated with similar modifications from respective parent team logos.

As discussed herein, bonus teams (e.g., bonus team 110-b and bonus team 115-b) may play amongst each other over the course of a season within the bonus league 105, and parent teams (e.g., parent team 110-a and parent team 115-a) may play amongst each other over the course of a season within the parent league 100. In some cases, the bonus league 105 season may not overlap, or only partially overlap, with the parent league 100 season (e.g., the bonus league 105 season may run in the spring and summer, as to not interfere with a parent league 100 season in the fall and winter). However, in some cases, the bonus league 105 season and the parent league 100 season may run concurrently (e.g., as described in more detail herein, for example, with reference to FIG. 5).

A bonus league 105 (e.g., and bonus teams within the bonus league 105) may generate new streams of revenue (e.g., for pairs of affiliated teams across the bonus league 105 and parent league 100). For instance, ticket prices may be cheaper for games played by bonus teams within bonus league 105. However, these games may still draw significant interest from spectators due to the name recognition and affiliation with a parent teams of interest. Such lower ticket prices may attract fans who cannot afford the high-ticket prices of parent league 100 games. These fans may get a similar stadium experience while watching the development of stars (e.g., popular players) within the bonus league 105. Such a bonus league 105 may be successful because of such marketing to a fan base now able to enjoy the same experience at a fraction of the cost. For further market expansion, a bonus league 105 may bring increased value to the established history, traditions, and nostalgia of the parent league 100 (e.g., as the combination of the parent league 100 and the bonus league 105 may appeal to a wider economic class and provide more content for heavily involved fans via leveraging of the team branding associated with the pair of affiliate teams).

For example, the bonus league 105 may provide these new fans with a matching experience (e.g., and existing fans with a duplicative experience), at a fraction of the cost. In some cases, each bonus league 105 player may be paid a flat rate, rather than the potentially disproportionate contracts parent league 100 players may receive. Because the price differential between running a bonus team, compared to running a parent team, ticket prices for bonus league 105 games may be relatively affordable. Bonus league 105 may charge ticket prices based on a fraction (e.g., 10% to 20%) of the ticket cost associated with the parent league 100 games. In some examples, overhead costs associated with the bonus league may be minimal as the bonus league 105 may utilize existing stadiums and practice facilities such that no new buildings or stadiums may be necessary (e.g., as described in more detail herein, for example, with reference to FIG. 5).

Generally, implementation of a bonus league 105 may increase the value of each parent team in the parent league 100 (e.g., and thus increase the value of the parent league 100 as a whole). For example, a bonus team 110-b may increase the value of an affiliate parent team 110-a, a bonus team 115-b may increase the value of an affiliate parent team 115-a, etc. For instance, any combination of a parent team's fair-market-value, gross annual revenues, television, streaming, broadcasting, clothing and apparel merchandise, food and beverage sales, sponsorship, marketing, advertising, goodwill, and other cash-flows generated may be increased by the addition and implementation of an affiliate bonus team. In some cases, the increase in value (e.g., additional revenue, profit, etc.) may be kept by the bonus team (e.g., and the bonus team may pay royalties or licensing fees to the parent team). In other cases, the increase in value (e.g., additional revenue, profit, etc.) may be divided between the parent team and the affiliate bonus team (e.g., in accordance with any licensing agreements, buy/sell agreements, etc.). Generally, the techniques described herein for establishment and operation of a bonus league may be applied to any league or sport. In some cases, the technique described herein may be implemented to efficiently establish a bonus league based on an existing professional league (e.g., such as the National Football League (NFL), Major League Baseball (MLB), National Basketball Association (NBA), Major League Soccer (MLS), etc.).

FIG. 2 shows an example of bonus league system according to aspects of the present disclosure. The example shown includes parent league 200 and bonus league 205. In some cases, parent league 200 may be an example of a first league, an existing league, a professional league, etc. and bonus league 205 may be an example of a second league, a bonus league, developmental league, etc. As described in more detail herein, bonus league 205 may be a bonus league affiliated with an existing parent league 200. Parent league 200 and bonus league 205 may thus include any number of affiliated teams, where the teams in parent league 200 compete amongst each other and the respective affiliate teams in bonus league 205 compete amongst each other.

In the example of FIG. 2, parent league 200 may include team 210-a and team 215-a, where team 210-a and team 215-a may compete against each other in accordance with parent league 200. Bonus league 205 may include team 210-b (e.g., which may be affiliated with team 210-a) and team 215-b (e.g., which may be affiliated with team 215-a), where team 210-b and team 215-b may compete against each other in accordance with bonus league 205. Parent league 200 may be an example of, or include aspects of, parent leagues 100, 300, and 400 as described with reference to FIGS. 1, 3, and 4. Bonus league 205 may be an example of, or include aspects of, bonus leagues 105, 305, and 405 as described with reference to FIGS. 1, 3, and 4.

As described herein, a bonus league (e.g., bonus league 205) may provide an opportunity for players, coaches, trainers, officials, cheerleaders, etc. to hone skills and augment talent beyond collegiate skills. The bonus league 205 may provide an extra layer of available talent to draw from, which may increase competition for roster spots within parent teams and generally increase competition and skill within a parent league (e.g., parent league 200). FIG. 2 may illustrate one or more aspects of how teams may be established within parent league 200 and bonus league 205, and how such establishment may provide for improved player resource management (e.g., including improved retention of talent, improved cultivation of talent, etc.

For instance, without a bonus league 205, parent teams within a parent league 200 may be limited regarding player resources (e.g., the number of players) that may be managed or retained. As an example, in some existing leagues, a team may discard almost an entire team over the course of early off-season training programs (e.g., where over 100 players may be on a roster) up until final cuts before the official start of a season (e.g., where 53 player may be on an active roster). In accordance with the techniques described herein, these discarded players may be used to make up their own bonus team, which may be staffed with its own coaching staff and play other bonus teams (e.g., in existing stadium venues, on new TV networks, on existing TV networks, etc.). The bonus league 205 season may thus operate as an additional and in many aspects duplicative parent league 200 season (e.g., which in some aspects may be analogous to a “varsity” team and a “junior varsity” team, in which the junior varsity team feeds the varsity team).

According to some embodiments of the described techniques, a pair of affiliate teams may share a preseason 220, as shown in FIG. 2. In general, evaluation of an initial roster 225 (e.g., during a shared preseason 220) may be used to select a final roster for a parent team and a bonus roster for an affiliated bonus team. For instance, an initial roster 225 may be identified for a parent team 210-a (e.g., a first team), players on the initial roster 225 may be evaluated, and a final roster for the parent team 210-a and a bonus roster for an affiliated bonus team 210-b (e.g., a second team) may be selected based on the initial roster 225 and the evaluation. Further, an initial roster 230 may be identified for a parent team 215-a (e.g., a first team), players on the initial roster 230 may be evaluated, and a final roster for the parent team 215-a and a bonus roster for an affiliated bonus team 215-b (e.g., a second team) may be selected based on the initial roster 230 and the evaluation.

The initial roster may include players. However, in some cases the initial roster may additionally include coaching staff, trainers, cheerleaders, and any other participants associated with a parent team (e.g., professional team) that may be evaluated for placement on the parent team or the affiliated bonus team. In some cases, a parent team and a bonus team (e.g., management of the parent team and management of the bonus team) may work together to identify the initial roster, evaluate the initial roster, select the final roster for the parent team, etc. In some cases, a parent team (e.g., management of the parent team) assume control or authority in identifying the initial roster, evaluating the initial roster, selecting the final roster for the parent team, etc. In other words, the bonus league 205 may be established to compliment the parent league 200 and thus bonus teams may be established to compliment and improve parent teams, however managerial decisions regarding player resources may be in the sole control of the parent team or may be split or shared to some extent across the parent team and the affiliated bonus team.

As an example, an initial roster (e.g., roster 225) may be identified based on players on a final roster from a previous season, based on free agents signed over an off-season time period, based on players drafted from collegiate leagues, based on players on an affiliated bonus roster from a previous season (e.g., based on high performers on the affiliated bonus team from the previous season), based on unsigned free agents after a player draft has been performed, etc. In some cases, such a roster 225 may be identified solely by parent team 210-a (e.g., by an owner of team 210-a, a general manager of team 210-a, one or more coaches or trainers of a coaching staff of team 210-a, etc.). In other cases, the initial roster 225 may be identified based at least in part on input or participation by bonus team 210-b (e.g., by an owner of team 210-b, a general manager of team 210-b, one or more coaches or trainers of a coaching staff of team 210-b, etc.). Similarly, a final roster for parent team 210-a may be identified from the initial roster 225 based on an evaluation and decisions by the parent team 210-a, or in some cases may be identified based on an evaluation and decisions by both the parent team 210-a and the bonus team 110-b.

As such, human resources (e.g., which may generally refer to any players, coaches, trainers, cheerleaders, etc.) for bonus teams (e.g., team 210-b and team 115-b) may include those who get cut from a respective parent team (e.g., team 210-a and team 215-a, respectively) before the first regular season game. Players for bonus teams may also include players from other countries (e.g., players from the Canadian Football League (CFL), as players may leave other leagues in attempt to join a bonus team in the bonus league 205 for better opportunities to work up to the parent league 200).

As an example, each parent team (e.g., team 210-b and team 215-b) may begin their preseason training (e.g., an annual fall camp) with, for example, approximately 100 players, various excess coaching and training staff, etc. By the completion of the preseason training, prior to the first regular season game (as parent league 200 rules may state), the final player count may be narrowed down to, for example, 53 players. As such, approximately 50 players may have been cut from each parent team in parent league 200, and these players may now be offered a position on the respective affiliate bonus team (e.g., which may establish a solid foundation for a competitive bonus team). Other options for bonus league 205 may include players who choose to leave other leagues in pursuit of ultimately joining the parent league 200. For instance, CFL players attempting to qualify for a National Football League (NFL) parent team may be offered a position on a National Football League Bonus (NFLB) team, giving them an opportunity to work their way up to the NFL.

A bonus league 205 described herein may thus provide parent teams in parent league 200 access to players that have stayed in shape and improved their skills against a high level of competition within the bonus league 205. Further, bonus league 205 may provide an opportunity for players to be evaluated and trained in a less “all or nothing” environment, extending the luxury of an optional backup plan (e.g., on an affiliated bonus team), benefiting both players and owners. Establishment of a bonus league 205 may prevent cases where a parent team may have otherwise scrambled to sign a player “off the streets” (e.g., midseason). The bonus league 205 may provide a reserve of ready to go players in case a player becomes injured on a parent team or when aging athletes have a level of play that has dropped off (e.g., midseason). The bonus league 205 may also prevent potential stars from slipping through the cracks (e.g., being cut from a parent team and not returning to the parent league) because they didn't have access to proper training facilities and nutrition, or because they pursued a different job for financial security after college.

A bonus league 205 may act analogous to an insurance plan for parent teams of the parent league 200. For instance, the bonus league 205 may be a remedy for “draft busts” where a player drafted by a parent team may not perform up to levels of expectation within the parent league 200. In some cases, such players of higher profile (e.g., of a higher draft selection) may draw significant interest in a bonus league 205 if not selected for a final roster of a parent team. Moreover, in some cases such player may develop within the bonus league and move up to the parent team for some subsequent season. In some examples, rookie players may underperform (e.g., or “hit the wall”) due to the lack of higher level of competition to hone their skills. A parent team (e.g., team 210-a) may temporarily shift these young players down to their affiliate bonus team (e.g., team 210-b), confident that they can bring them back once the area of inadequacy in the player's game has been enhanced.

As such, in some cases, a bonus league 205 may effectively eliminate various factors that may contribute to the demise of a player. Further, bonus teams do so while also providing tangible profit (e.g., in the way of fans) for the pair of affiliate teams. With a commitment toward building successful bonus teams and a successful bonus league 205 as a whole, individual players (e.g., regardless of position) may be paid a reasonable wage with a signing bonus. In some cases, players may be provided with a room/board option that includes nutritional meal plans, and players may be trained by coaches. A bonus league 205 that covers these aspects may enable each player on various bonus teams to focus more fully on developing their skills, talents, and abilities as they pursue excellence and advancement into the parent league 200.

Ongoing development provided by a bonus league 205 is not limited to players. For instance, expertise for various positions and roles associated with a parent team may be gained through experience on an affiliated bonus team. Any bonus team personnel and staff including (e.g., but not limited to) coaches, coordinators, team doctors, trainers, cheerleaders, etc. may be recognized for their skill development as they pursue advancement into the next level.

As discussed herein, the bonus league 205 may adopt one or more aspects of the parent league 200. For example, the bonus league 205 may adopt parent league 200 rules, regulations, policies, etc. Further, in accordance with some aspects, the bonus league 205 may groom (e.g., perform trials on and evaluate) one or more of such aspects of the parent league 200. Generally, the bonus league 205 may have little to no conflict with the parent league 200 regarding the rules regulating teams, or games, or how other policies are applied. In some cases, the bonus league 205 may implement and evaluate rules changes, policy changes (e.g., changes in player conduct policies, player contract terms, spectator conduct policies, etc.), etc. For instance, in some cases, policy differences enacted in the bonus league 205 may be aimed at capturing a new fanbase or market segment, recapturing a lost fanbase or market segment, etc. In some examples, a second set of rules for game play in the bonus league 205 may include experimental rules, experimental policies, experimental regulations, etc. may be selected for trial and evaluation within the bonus league 205 (e.g., for consideration of whether any of the experimental rules, experimental policies, experimental regulations, etc. should be included or implemented in the parent league 200).

Further, in some examples, a bonus team 205 may implement a same or similar playbook as an affiliated parent team 200. As such, in addition to improving management of player resources for a parent team (e.g., via maintaining a bonus roster on the affiliated bonus team), the bonus team may also employ the same offensive schemes, defensive schemes, play calls, strategies, etc. as the affiliated parent team. Bonus league 205 coaches and trainers may be involved from the beginning of offseason training activities (e.g., throughout a preseason 220) in order to learn the affiliate parent team's playbook. In some cases, a parent team may employ a first playbook, and the affiliate bonus team may employ a second playbook that is based on the first playbook. In some cases, the second playbook may include new plays to be tested and evaluated by the bonus team (e.g., where new plays with high evaluations or high success rates may be ultimately included into the first playbook for implementation by the affiliated parent team).

In the example of FIG. 2, parent team 210-a and affiliate bonus team 210-b may share a preseason 220 where an initial roster 225 may be evaluated. Based on the evaluation, a final roster may be selected for the parent team 210-a and a remaining bonus roster may be selected for the affiliate bonus team 210-b. Further, parent team 215-a and affiliate bonus team 215-b may share a preseason 220 where an initial roster 230 may be evaluated. Based on the evaluation, a final roster may be selected for the parent team 215-a and a remaining bonus roster may be selected for the affiliate bonus team 215-b. In some cases, the bonus roster may be selected incrementally over time. For instance, a parent league 205 may institute deadlines for when an initial roster is to be reduced to a certain number of players (e.g., such that parent teams may cut a number of players on the initial roster according to certain dates or deadlines). In such cases, the bonus roster may be selected incrementally with each batch of one or more players that are cut from each round of cuts associated with a parent team during preseason evaluations. In other words, a majority of the bonus roster may be selected all at once following the last game of the preseason 220 (e.g., when parent teams announce final cuts and a final roster, such that all players under the final cuts are selected for the bonus roster for further development in the bonus league 205).

As such, parent team 210-a and parent team 215-a may compete within parent league 200, and bonus team 210-b and bonus team 215-b may compete within bonus league 205. Bonus team 210-b may thus provide for improved human resource (e.g., including players, coaches, trainers, etc.) management via enabling the pair of affiliate teams to maintain and develop additional human resources compared to what would otherwise be possible by parent team 210-a alone. For instance, bonus team 210-b may run a same playbook as parent team 210-a. As such, the bonus roster of bonus team 210-b may gain familiarity and experience (e.g., in actual games played within bonus league 205) with plays and schemes implemented by parent team 210-a within parent league 200. As such, human resources (e.g., players, coaches, etc.) may be brought up from bonus team 210-b to the affiliate parent team 210-a (e.g., mid-season or at the beginning of a subsequent preseason 220) already familiar and up to speed with various aspects of how the parent team 210-a operates.

As discussed herein, the bonus league 205 may not directly compete with the parent league 210 (e.g., in terms of spectator viewership, merchandise sales, etc.). Rather than competing with the parent league 200, bonus league 205 may augment options for the fanbase of the parent league 200. For instance, the bonus league 205 may highly value and respect the tradition, history, and nostalgic memories the parent league 200 has established. The bonus league 205 may thus recognize this value added by the parent league 200 (e.g., and thus establishment of a bonus league 205 may entertain favorable licensing to each parent team in the parent league 200).

In some cases, in order to better accommodate affiliation with the existing parent league 200, playoff competition within the bonus league 205 may be further structured around playoff competition within the parent league 200. For instance, protocols for the bonus league 205 playoffs may use a same format as the current parent league 200 playoffs. In some examples, a bonus league 205 may use the offseason to hold an bonus league 205 playoffs or may use simultaneous playoffs with the parent league 200 (e.g., to entice cities/fans of the parent teams that do not make the playoffs to support their team's affiliate bonus team that may have made the playoffs). For instance, in some examples, parent team 210-a may have not made the playoffs or may have been eliminated from the playoffs, in such cases, the affiliate bonus team 210-b may benefit from additional interest from the fan base of the pair of affiliate teams. In some cases (e.g., in cases of a noncompete covenant between the bonus league 205 and the parent league 200), the bonus league 205 playoffs may be scheduled to start and finish the week following the parent league 200 playoffs.

As an example, bonus league 205 and parent league 200 may have similar protocols or formats for playoffs, which may include a wild card round, a divisional round, a conference championship, a parent league championship weekend (e.g., a super bowl weekend), and a bonus league championship (e.g., a bonus league super bowl). A wild card round for the bonus league 205 may begin on Friday night and Monday night of the same weekend as the parent league 200 divisional rounds (e.g., a wild card round playoff games for the bonus league 205 may be held on the Friday and Monday surrounding parent league divisional round games which may include, for example, an American Football Conference (AFC) divisional round games and National Football Conference (NFC) divisional round games). That is, the start of the bonus league 205 playoffs may be scheduled to begin the week following the parent league 200 playoff start. The divisional round for the bonus league 205 may begin on Friday night and Saturday afternoon of the same weekend as the parent league 200 conference championships (e.g., which, for a football parent league, may include an AFC conference championship game and an NFC conference championship game).

In some examples, conference championship round games for the bonus league 205 may be played on Saturday of the same weekend as a Sunday Pro Bowl of the parent league 200. In some cases, the championship (e.g., Super Bowl) week and weekend of the parent league 200 may not be encroached upon by the bonus league 205 playoffs. The bonus league 205 may have a bye week during a championship weekend of the parent league 200. As such, for fanbases not ready for the affiliate leagues' season to end, the bonus league 205 championship may be played the Sunday following the championship weekend of the parent league 200.

In some cases, establishment of a bonus league 205 may disrupt other leagues (e.g., other amateur or semi-pro leagues with a same focus, or sport, as a parent league 200). For example, as discussed above, players for bonus teams may ultimately include players from other countries (e.g., players from the CFL, as players may leave other leagues in attempt to join a bonus team in the bonus league 205 for better opportunities to work up to the parent league 200). In such cases, expansion of the parent league 200 and the bonus league 205 may consider such disruption to other leagues. For instance, in the example where the CFL may be disrupted, additional parent teams and affiliate bonus teams may be established in Canada (e.g., in major border cities, such as Vancouver, British Columbia, etc.).

FIG. 3 shows an example of bonus league system according to aspects of the present disclosure. The example shown includes parent league 300 and bonus league 305. In some cases, parent league 300 may be an example of an existing league, a professional league, etc. and bonus league 305 may be an example of a bonus league, developmental league, etc. As described in more detail herein, bonus league 305 may be a bonus league affiliated with an existing parent league 300. Parent league 300 and bonus league 305 may thus include any number of affiliated teams, where the teams in parent league 300 compete amongst each other and the respective affiliate bonus teams in bonus league 305 compete amongst each other.

In the example of FIG. 3, parent league 300 may include team 310-a and team 315-a, where team 310-a and team 315-a may compete against each other in accordance with parent league 300. Bonus league 305 may include team 310-b (e.g., which may be affiliated with team 310-a) and team 315-b (e.g., which may be affiliated with team 315-a), where team 310-b and team 315-b may compete against each other in accordance with bonus league 305. Parent league 300 may be an example of, or include aspects of, parent leagues 100, 200, and 400 as described with reference to FIGS. 1, 2, and 4. Bonus league 305 may be an example of, or include aspects of, bonus leagues 105, 205, and 405 as described with reference to FIGS. 1, 2, and 4.

As described herein, a bonus league (e.g., bonus league 305) may provide an opportunity for players, coaches, trainers, officials, cheerleaders, etc. to hone skills and augment talent beyond collegiate skills. The bonus league 305 may provide an extra layer of available talent to draw from, which may increase competition for roster spots within parent teams and generally increase competition and skill within a parent league (e.g., parent league 300). FIG. 3 may illustrate one or more aspects of how bonus team 310-b and bonus team 315-b may be implemented for improved utilization and management of human resources (e.g., players) by parent team 310-a and parent team 315-a, respectively.

In some cases, affiliate bonus teams may leveraged by parent teams in order to protect parent team investments and identified talent. For instance, in some cases, rather than cut players exceeding roster limits associated with a regular season (e.g., such that another parent team may pick up or sign any of the cut players), players (e.g., or coaches, trainers, etc.) may be selected for a bonus roster associated with a bonus team affiliated with the parent team. As such, excess players from an initial roster initially associated with team 310-a may be selected for a bonus roster for affiliate bonus team 310-b. As such, parent team 310-a may protect and develop their investments and identified draft talent without the risk of losing players, coaches, etc. to another team, such as another parent team 315-a. Such is illustrated in the example of FIG. 3, where human resources (e.g., players) may be exchanged between a pair of affiliate teams (e.g., bonus team 310-b and parent team 310-a), but not necessarily from bonus team 310-b to a non-affiliate parent team 315-b. As such a parent team (e.g., team 310-a) may temporarily shift young players, older players, injured players, less experienced players, etc. down to their affiliate bonus team (e.g., team 310-b), confident that they can bring them back once the area of inadequacy in the player's game has been enhanced.

In some examples, once a final roster has been selected (e.g., after a joint preseason), players may only move from the bonus roster up to a parent roster (e.g., and not from a parent roster down to a bonus roster) in order to replace any players displaced from the parent roster due to player injuries on the parent roster, due to a player being dropped entirely from the pair of affiliate teams by the parent team, etc. In other words, bonus leagues may be implemented such that human resources may flow freely between a bonus team and a parent team, or bonus leagues may be implemented such that, once a final roster for the parent team and a bonus roster for the bonus team is set (e.g., in accordance with roster limits or roster cut dates imposed by the parent league 300), human resources may only flow from the bonus team to replace displaced personnel on the affiliated parent team.

FIG. 4 shows an example of league affiliation diagram according to aspects of the present disclosure. The example shown includes parent league 400 and bonus league 405. In some cases, parent league 400 may be an example of a first league, an existing league, a professional league, etc. and bonus league 405 may be an example of a second league, a bonus league, developmental league, etc. As described in more detail herein, bonus league 405 may be a bonus league affiliated with an existing parent league 400. Parent league 400 and bonus league 405 may thus include any number of affiliated teams, where the teams in parent league 400 compete amongst each other and the respective affiliate teams in bonus league 405 compete amongst each other.

In the example of FIG. 4, parent league 400 may include team 410-a, team 415-a, team 420-a, and team 425-a, where team 410-a, team 415-a, team 420-a (e.g., and team 425-a may compete against each other in accordance with parent league 400). Bonus league 405 may include team 410-b (e.g., which may be affiliated with team 410-a), team 415-b (e.g., which may be affiliated with team 415-a), team 420-b (e.g., which may be affiliated with team 420-a), and team 425-b (e.g., which may be affiliated with team 425-a). Accordingly, team 410-b, team 415-b, team 420-b, and team 425-b may compete against each other in accordance with bonus league 405. Parent league 400 may be an example of, or include aspects of, parent leagues 100, 200, and 300 as described with reference to FIGS. 1-3. Bonus league 405 may be an example of, or include aspects of, bonus leagues 105, 205, and 305 as described with reference to FIGS. 1-3.

As described herein, each bonus team may have the opportunity to directly contribute to the success of its affiliated parent team. Specifically, each bonus team's success may impact the parent team's chance for higher draft picks, may improve the parent team's placement in the drafting order in expanded drafting rounds, may increase a number of draft pick selections for a parent team, may determine homefield advantage for one or more games within the parent league, may affect (e.g., increase or decrease) a number of available spots on a bonus roster for a subsequent season, etc. The example of FIG. 4 is provided for illustrative purposes, however, various draft configurations (e.g., with different ordering, different numbers of draft rounds, with different numbers of parent teams participating in the draft, with certain parent teams selecting more than once or not at all in a particular draft round, etc.) are considered by analogy, without departing from the scope of the present disclosure.

To provide an opportunity for mutual success of the parent teams and the bonus teams, team results of the first parent league 400 and the second bonus league 405 may influence each other. FIG. 4 shows an example scenario of a supplemental draft of a first round, second round, and third round, etc. A bonus team may influence an affiliate parent team's draft order by completing a season with higher final league position. For example, a parent team may have improved draft picks (e.g., earlier draft selections, more draft selections, etc.) when an associated bonus team has a higher final league position.

In some examples, parent team of first parent league 400 may participate in a supplemental draft round based on the associated bonus team's record in the second bonus league 405. In an example scenario, bonus teams compete against each other to earn the associated parent team a higher pick in the supplemental draft round. In some examples, the supplemental draft round may be held between the first and second round of regular draft selection. The supplemental draft round may award the first draft decision to the parent team of the bonus team holding the best record, and the second draft decision to the parent team of the bonus team holding the second best record, and so on to the end of the participating teams. The parent team with the lowest bonus team season record may pick last. The better a bonus team's season record, the higher the parent team will pick in the supplemental draft round.

Referring to FIG. 4, first parent league 400 and second bonus league 405 may participate in a single draft (e.g., in the example of FIG. 4, each pair of affiliate teams gets one selection in each of rounds 1-3). Draft order 430-a may illustrate the order in which parent teams (e.g., or the pair of affiliate teams) select draft picks. Draft order 430-a may be determined based on the regular season of the parent league 400 (e.g., where the team with the lowest record, team 410-a, selects first and where the team with the highest record, team 425-a, selects last, etc.). In some cases, draft order 430-a may be determined based on trades (e.g., draft pick for draft pick trades, draft pick for player trades, etc.) amongst parent teams within parent league 400. However, as described herein, draft order 430-b (e.g., a supplemental draft round) may be determined based on the regular season and/or playoff of the bonus league 405 (e.g., bonus team ranking or results in bonus league 405 may ultimately dictate the draft order of the parent teams in, for example, draft round 2). In the present example, draft order 430-b may be established based on rankings (e.g., post bonus league 405 season rankings, post bonus league 405 playoff rankings, etc.) within the bonus league 405 (e.g., wherein bonus team 420-b may rank first, bonus team 425-b may rank second, bonus team 410-b may rank third, and bonus team 415-b may rank fourth).

In some cases, the draft order may continue with an alternating process of regular draft and supplemental draft order, there may be a single supplemental draft order in round 2, there may be additional draft rounds added to existing parent league drafts to accommodate the additional bonus roster maintained via established bonus leagues, etc., as the present disclosure is not limited thereto. For instance, in some cases, as a result of the supplemental draft round and additional players in both first parent league 400 and second bonus league 405, a player draft may have an increased number of rounds. The increased quantity of teams and players used for the bonus teams may result in the number of rounds in the draft to be increased (e.g., by three or more rounds). As the supplemental draft round format continues, additional draft rounds may follow the same structure. For example, the better a bonus team's season record, the higher (e.g., the improved) the associated parent team's draft selections in expanded draft rounds. In some cases, this new variation regarding determination of the supplemental round draft order (e.g., draft order 430-b) may increase player and fan-base valuation of the relationship between the parent team and affiliated bonus team, encouraging unified loyalty and support of the pair of affiliate teams (e.g., of the team brand name).

FIG. 5 shows an example of league affiliation diagram according to aspects of the present disclosure. For instance, FIG. 5 may illustrate one or more aspects of improved resource sharing across a bonus league and a parent league as described herein. FIG. 5 may include 6 pairs of affiliate teams (e.g., parent team 505-a and bonus team 505-b, parent team 510-a and bonus team 510-b, parent team 515-a and bonus team 515-b, parent team 520-a and bonus team 520-b, parent team 525-a and bonus team 525-b, and parent team 530-a and bonus team 530-b). Further, FIG. 5 may illustrate how pairs of affiliate teams may share resources (e.g., such as stadiums, season game play schedules, travel schedules, travel accommodations, etc.).

As described, in some embodiments no new buildings or stadiums may be built to support the additional players and teams of the bonus league (e.g., at least on pair of affiliate teams may share a stadium, training facilities, etc.). The bonus teams may use the facilities already in existence, used by the parent team. In some examples, each team may use the same practice/training facility, rotating usage of the stadium between the parent and bonus teams. In the example of FIG. 5 team 505-a and team 505-b may share stadium 545 (e.g., for home games), team 510-a and team 510-b may share stadium 550 (e.g., for home games), team 515-a and team 515-b may share stadium 555 (e.g., for home games), team 520-a and team 520-b may share stadium 560 (e.g., for home games), team 525-a and team 525-b may share stadium 565 (e.g., for home games), and team 530-a and team 530-b may share stadium 570 (e.g., for home games).

In some embodiments, both the parent team and the affiliated bonus team may play a corresponding pair of opponent affiliated teams on the same day or within a same date range (e.g., over a same weekend). In some cases, game times may be scheduled to provide a “doubleheader” option for team fans each Sunday, Monday, or Thursday (e.g., for Monday night and Thursday night football). The bonus league may not compete with the parent league, the bonus league may complement the parent league. Events (e.g., games) may be scheduled for each team with staggered times versus staggered seasons. For example, the bonus team may play on Saturday, while the parent team plays on Sunday. Additionally or alternatively, the bonus team may play at before the parent team on a same day, or vice versa, but the present disclosure is not limited thereto.

In some cases, fans excited about their favorite teams (e.g., their favorite pair of affiliate teams) may look forward to watching both games (e.g., the parent team's game in the parent league and the affiliated bonus team's game in the bonus league) back-to-back, particularly fans who have already blocked out their day to watch one of the games anyways. As an example of a doubleheader, the bonus league game in matchups 535 (e.g., the matchup between the home bonus team 505-b and the away bonus team 525-b) may be followed by the parent league game in matchups 535 (e.g., the matchup between the home parent team 505-a and the away parent team 525-a). In some cases, the bonus league game may be followed by the venue broadcasting the parent league game on a Jumbo TV (e.g. at Century Link field in Seattle), whereby all the remaining fans could watch the parent league game live. When the parent league game is played in the earlier time slot, bonus league game ticket holders may be given the option to arrive early (e.g., 3 hours prior) to the bonus league game in order to watch the parent game broadcasted on the Jumbo Screen Media.

Another feature of the bonus league is that new (stadium/training facilities) may be shared to at least some extent amongst pairs of affiliate teams (e.g., and new infrastructure may not necessarily be built or otherwise acquired). Each existent facility will be used by the parent team and their affiliated bonus team by alternating and rotating facilities. As discussed, a pair of affiliate teams may share a stadium, work out facility, media room, locker room, etc.

Further, a pair of affiliate teams may share similar scheduling (e.g., to reduce travel costs, to facilitate sharing of stadiums, to foster cross-promotion within a pair of affiliate teams, etc.). In other words, a season schedule for a bonus league may align traveling between the parent league and the bonus league and may allow sharing of stadiums for matchups within the parent league and the bonus league. Specifically, season schedules may be set such that each pair of affiliate teams may effectively share a respective home stadium, travel to face another pair of affiliate teams, share travel costs (e.g., means for transportation, travel accommodations, etc.). Therefore, the bonus teams may generally travel with the parent team to play the bonus team affiliated with the opponent of the parent team. For instance, in the present example, team 530-a and 530-b may travel away to play matchups 575 against team 530-a and 530-b in stadium 650. In some cases, FIG. 5 may illustrate aspects of a season schedule for the bonus league and the parent league (e.g., FIG. 5 may illustrate a travel schedule for matchups 535, matchups 540, and matchups 575 for a given game week within a regular season or playoffs).

In some embodiments, FIG. 5 may also illustrate one or more aspects of techniques for establishment of the bonus league. For examples, as described herein, a bonus league (e.g., a second athletic league) may be assembled by identifying a first set of parent teams that competes in a parent league (e.g., a first athletic league) that is affiliated with the bonus league, identifying a second set of bonus teams to compete in the bonus league (e.g., where each bonus team uses a team branding of a respective parent team), and select a bonus roster for each bonus team that includes players that are not selected for a final roster for the respective parent team.

Further, bonus teams may be identified such that the bonus teams may be affiliated with a parent team in a same geographic area, such that bonus teams may share facilities and other resources with a parent team, etc. For instance, to identify potential bonus teams, a geographical region associated with a parent team may be identified, and an affiliated bonus team may be identified such that the affiliated bonus team may reside in the same geographical region (e.g., city) and share an existing stadium used by the parent team. For example, a bonus team 525-b may be identified based on an existing parent team 525-a. The bonus team 525-b may thus be established and operated within a similar or same geographic region as the existing parent team 525-a, and the bonus team 525-b may share team branding with the existing parent team 525-a (e.g., such that the bonus team 525-b may be injected into the existing fanbase associated with the existing parent team 525-a and thus may leverage fanbase adoption based on name recognition). Moreover, the bonus league may determine a schedule for the bonus team 525-b such that the bonus team 525-b game play schedule may generally align with the game play schedule of the affiliate parent team 525-a (e.g., such that the pair of affiliate teams may generally align in travel schedules, may share resources such as home stadium 565 and away stadium 545 for example matchups 535, may share coaching staff, trainers, cheerleaders, etc. that may travel together and participate in relatively aligned games, etc.).

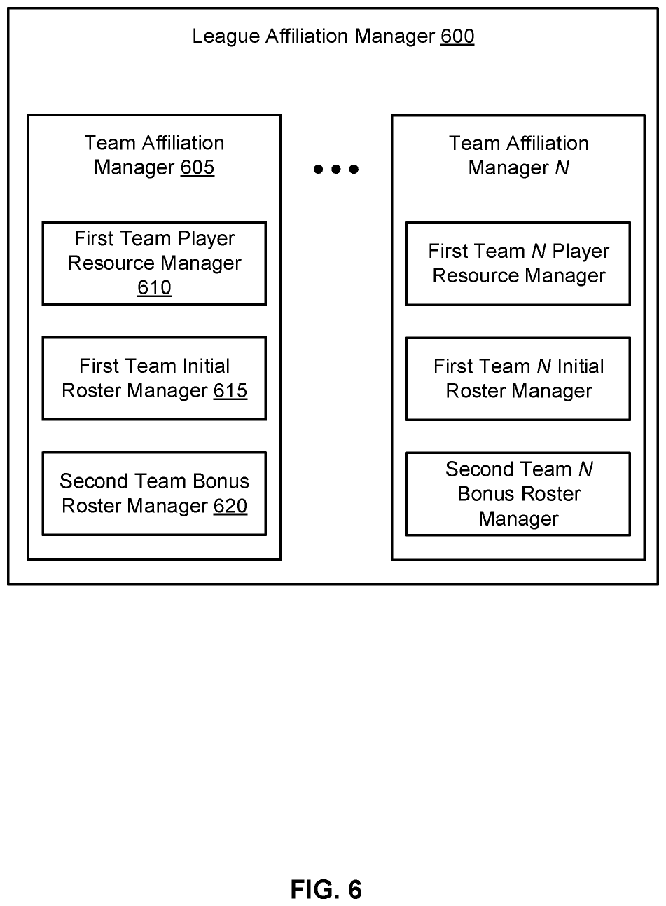

FIG. 6 shows an example of a system for establishing a competition league according to aspects of the present disclosure. For instance, the example system may include a league affiliation manager 600. League affiliation manager 600 may manage or otherwise operate one or more aspects of league affiliation (e.g., licensing agreements, buy/sell agreements, branding agreements, merchandising agreements, cooperation agreements, etc.) between a parent league (e.g., a first athletic league) and a bonus league (e.g., a second athletic league) as described herein. League affiliation manager 600 may include one or more team affiliation managers (e.g., N team affiliation managers, including at least team affiliation manager 605). Team affiliation manager 605 may manage or otherwise operate one or more aspects of team affiliation (e.g., agreements, licensing, branding, cooperation, etc.) between a parent team (e.g., a first team) and a bonus team (e.g., a second team) as described herein.

League affiliation manager 600 may manage (e.g., establish, operate, provision, etc.) a bonus league (e.g., a second league) and an affiliate league (e.g., a first league). League affiliation manager 600 may manage one or more aspects of interleague resource sharing (e.g., resources shared commonly or analogously across each pair of affiliate teams). For instance, league affiliation manager 600 may manage aspects such as overall or combined league branding and likeness, alignment of affiliate teams travel schedules, management of certain trial aspects and consistent aspects across the bonus league and the affiliate league, etc. Team affiliation manager 605 may manage (e.g., establish, operate, provision, etc.) a team in an affiliate league (e.g., a first league) and a team in a bonus league (e.g., a second team). Team affiliation manager 605 may manage one or more aspects of affiliate team resource sharing (e.g., resources shared between a pair of affiliate teams). For instance, team affiliation manager 605 may manage aspects such as shared of team branding and likeness, shared stadium usage, shared merchandising, shared rights to player resources, etc.

Team affiliation manager 605 may include first team player resource manager 610, first team initial roster manager 615, and second team bonus roster manager 620. First team player resource manager 610 may manage player resources associated with a team in the first league (e.g., which may include selection of a final roster, from an initial roster, for the team in the first league). First team initial roster manager 615 may manage an initial roster for a team in the first league (e.g., which may include drafting players for an initial roster for the team in the first league). Second team bonus roster manager 620 may manage a bonus roster for a team in the second league (e.g., which may include managing remaining players for an affiliate team in the first league that were not selected for the final roster of the affiliate team in the first league).

In some cases, a first athletic league may be an example of, or include aspects of, any of leagues 100, 200, 300, and 400 described with reference to FIGS. 1-5. In some cases, a second athletic league may be an example of, or include aspects of, any of leagues 105, 205, 305, and 405 described with reference to FIGS. 1-5. In some cases, a first team (or a first set of teams) may be an example of, or include aspects of, any of teams 110-a, 115-a, 210-a, 215-a, 310-a, 315-a, 410-a, 415-a, 420-a, 425-a, 510-a, 515-a, 520-a, 525-a, and 530-a described with reference to FIGS. 1-5. In some cases, a second team (or a second set of teams) may be an example of, or include aspects of, any of teams 110-b, 115-b, 210-b, 215-b, 310-b, 315-b, 410-b, 415-b, 420-b, 425-b, 510-b, 515-b, 520-b, 525-b, and 530-b described with reference to FIGS. 1-5.

League affiliation manager 600 may identify a first set of teams that competes in a first athletic league that is affiliated with the second athletic league. League affiliation manager 600 may also identify a second set of teams to compete in the second athletic league, where each team in the second set of teams uses a team branding of a respective team in the first set of teams. In some examples, the second team branding includes one or more differences from the first team branding that are the same as team branding differences between each team in the second set of teams and their respective team in the first set of teams. League affiliation manager 600 may also identify a second game play schedule for the second athletic league based on a first game play schedule for the first athletic league, where the first game play schedule and the second game play schedule align traveling between the first athletic league and the second athletic league, allow sharing of a stadium between the first athletic league and the second athletic league, or both. League affiliation manager 600 may also identify a second set of game rules for the second athletic league that are substantially the same as a first set of game rules for the first athletic league. In some examples, the second set of game rules includes one or more experimental rules selected for evaluation for inclusion in the first set of rules. In some examples, a result of a season in the second athletic league impacts access to player resources by the first set of teams in a subsequent season in the first athletic league.

Team affiliation manager 605 may select a bonus roster for each team in the second set of teams, where the bonus roster for each team in the second set of teams includes players that are not selected for a final roster for the respective team in the first set of teams. Team affiliation manager 605 may also identify the second set of teams where each team in the second set of teams uses the team branding of the respective team in the first set of teams includes. Team affiliation manager 605 may also identify a geographical region associated with a first team in the first set of teams. Team affiliation manager 605 may also identify a first team branding for the first team in the first set of teams. Team affiliation manager 605 may also identify a second team in the second set of teams based on the first team branding, where a second team branding for the second team is substantially the same as the first team branding based on the second team being associated with the geographical region. In some examples, the first athletic league and the second athletic league share a preseason training camp and the bonus roster for each team in the second set of teams is selected after the shared preseason training camp. In some examples, each team in the second set of teams employs a first playbook based on a second playbook that is employed by the respective team in the first set of teams. In some examples, a final season ranking of each team in the second set of teams impacts a player drafting order of a respective team in the first set of teams.

First team initial roster manager 615 may identify an initial roster for a first team, where the first team competes in a first athletic league. First team player resource manager 610 may evaluate players on the initial roster. First team player resource manager 610 may also select a final roster for the first team based on the initial roster and the evaluation. In some examples, the evaluation of each player on the initial roster is performed during a preseason training camp. First team player resource manager 610 may also select one or more players from the bonus roster for the first team based on evaluation of the players on the bonus roster. First team player resource manager 610 may also play one or more preseason games using the initial roster. In some examples, the initial roster and the final roster are selected based on roster limits enforced by the first athletic league.

Second team bonus roster manager 620 may select a bonus roster for a second team affiliated with the first team, where the bonus roster includes players that are not selected for the final roster, and where the second team competes in a second athletic league. Second team bonus roster manager 620 may also evaluate players on the bonus roster.

In some examples, a first set of game rules for the first athletic league are substantially the same as a second set of game rules for the second athletic league. In some examples, the second set of game rules includes one or more experimental rules selected for evaluation for inclusion in the first set of game rules. In some examples, the first team is associated with a first team branding that is substantially the same as a second team branding for the second team. In some examples, the second team branding includes one or more differences from the first team branding that are uniform across teams in the second league. In some examples, the first team employs a first playbook, and the second team employs a second playbook that is based on the first playbook.

In implementation, a bonus league (e.g., a second athletic league) may create new jobs and new sports opportunities in tandem with an affiliate league (e.g., a parent league, a first athletic league, an existing league, etc.). The bonus league may provide for additional entertainment and sports commentary in terms of additional games, storylines, etc. (e.g., the bonus league may provide for new stories and sports topics centered around one or more of the various nuances for how the bonus league coexists with the parent league, as described herein).

In some examples, to establish a bonus league (e.g., to establish an affiliate relationship between a new bonus league and an existing parent league) a transaction planning and implementation memorandum (TPIM) may be distributed to various “recipients” (e.g., which may include third party investors, groups or individuals with ownership in the parent league, etc.). In some cases, each parent team (e.g., each team in the first athletic league) may immediately increase their market value (e.g., by 10% or more), resulting in new creation of value, with favorable licensing agreements. Further, a principal buy-in partner (e.g., a non-parent league team parent owner), may purchase a buy-in to also set-up and receive lucrative royalties, in which recipients of the TPIM of other investors in the bonus league can win, in a “win-win-win” scenario.

The TPIM may detail how to properly implement features of a bonus league for all recipients of the TPIM to benefit (e.g., ultimately profit on an investment), by solving issues for the existing parent league (e.g., and creating new jobs and employment opportunities in communities of the bonus league and existing parent league). The TPIM may provide guidance and details on how to roll-out a bonus league and how to manage various team owners (e.g., team owners within the parent league and team owners within the bonus league), commissioners (e.g., a commissioner of the parent league and a commissioner of the bonus league).

In some cases, a private trust may be established. The private trust may own various (e.g., and in some cases all) rights, title, and interest in certain proprietary intellectual property claims/filings recorded with various domestic and international organizations. In some cases, the trust may be known or referred to as the bonus league. In some examples, in order for recipients of the TPIM to approve, agree to, and accept all the terms, conditions, and covenants of the TPIM (e.g., and to be legally bound thereto), each recipient of the TPIM may act with the intent to be bound, such as, but not limited to approving, agreeing to, and accepting a license agreement, or approving, agreeing to, and accepting a buy/sell agreement, of which some steps are described in more detail herein.

The TPIM may be delivered to each owner, ownership group, or ownership structure for each of the separate parent teams within the parent league (e.g., and the owner, ownership group, or ownership structure may also be referred to as a licensee or licensees). The TPIM may also be delivered to principal buy-in partners or target partners to the bonus league. For instance, the TPIM may be delivered to influential sports potential partners, which may include owners of teams in sports leagues other than the sport associated with the parent league and the bonus league. In some cases, an owner of a team in the parent league may not be permitted to buy in as an owner of a team in the bonus league (e.g., as that particular team owner may then otherwise have too much power and influence over the other owners in the parent league, the bonus league, or both). Further, the TPIM may also be delivered to any standing commissioner (e.g., or other governing positions or governing groups) of the existing sports league.

In some cases, recipients of the TPIM may be encouraged to publicly discuss the contents of the TPIM (e.g., prior to official establishment of the bonus league). For instance, public disclosure and open conversation (e.g., informed based on the contents of the TPIM) may add to positive sentiment and public support for the roll-out of the bonus league. The public release of contents included within the TPIM to the general public may facilitate acquiring of public feedback as well as gaining momentum behind implementing aspects of the bonus league. Public feedback and positive sentiment may be important in order to encourage any parent league team owners to participate in bonus league licensing agreements and to properly roll-out the bonus league. Further, in some cases, public domain knowledge of timelines (e.g., which may include some non-negotiable terms, conditions, and covenants) may facilitate negotiating between parties of the parent league, the bonus league, and any trust or third party involvement in establishment of the bonus league.

A bonus league may benefit parent league team owners (e.g., owners of parent teams participating in the parent league, any ownership in the parent league, etc.) because the bonus league may substantially increase the market value of teams within the parent league. If implemented efficiently, establishment of the bonus league may be associated with relatively low start-up efforts and costs (e.g., relative to the additional revenue opportunities presented by establishment of a bonus league).

As an example, each of the parent league team owners may increase revenue with the full roll-out of the bonus league because implementation of a bonus league described herein may increase the value of each parent team in a parent league (e.g., by 10% or more). For instance, any combination of a parent team's fair-market-value, gross annual revenues, television, streaming, broadcasting, clothing and apparel merchandise, food and beverage sales, sponsorship, marketing, advertising, goodwill, and other cash-flows generated may be increased. In an example where a parent league includes thirty-two (32) teams multiplied by a $2 billion average fair-market-value for each existing league parent team, in the present example the bonus league may be valued at a ten percent (10%) increase in overall value (e.g., calculated as $6.4 billion). Television revenues, marketing, advertising, clothing, and apparel may also be affected and factored at $10 billion, such that when multiplied by a ten percent (10%) increase in value from the bonus league may result in an additional $1.0 billion. In such an example, implementing the bonus league may result in this additional $7.4 billion.

Each of the existing league parent team owners may also realize value as, outside of setting aside a smaller amount for a budget of its affiliated bonus team in the affiliate bonus league (e.g., $10,000,000), there may be no other costs associated with start-up and in the first year of operation of the bonus league the existing league parent team owner may keep a high percentage (e.g., 80%) of net operating income and may pay out a less percentage (e.g., 10%) of net operating income to the bonus league. In some cases, a small percentage (e.g., 10%) of net operating income may go towards, for example, charitable causes (e.g., which in some cases may be stated in licensing agreements).

For instance, in a given year, an existing league parent team may have generated reported revenues of approximately $413 million, with operating income topping $71 million. Additionally, the existing league parent team may have generated roughly $63 million in ticket sales. The parent team in an existing league may set aside (e.g., allocate, invest, etc.) a portion of generated revenues (e.g., $10 million) for funding the affiliate bonus team in the bonus league. Bonus league team goals (e.g., regarding costs associated with each bonus league team) may be under, for example, $8 million per team. For instance, a bonus league team may budget $100 thousand for each player, per year (e.g., 53 players, plus 12 practice squad players=Budget $6.5 million for players) $1.77 million for coaches, team doctors, trainers, ancillary personnel, and travel, thus creating a total annual budget of approximately $7.77 million per team. Any additional money (e.g., $2.33 million remaining from the allocated $10 million from the parent team) may be budgeted for contingency reserve. Bonus league income goals may be some percentage (e.g., at least 20%) of the existing league parent team's revenues. Considering the present example, the affiliated bonus league team may make approximately $80 million in revenues (e.g., 20% of the existing league parent team's revenues of $413 million=$80 million, $10 million of which may go towards its own expenses as discussed above, leaving approximately $70 million as operating income for the parent team owner, for the bonus team league owner, etc.).

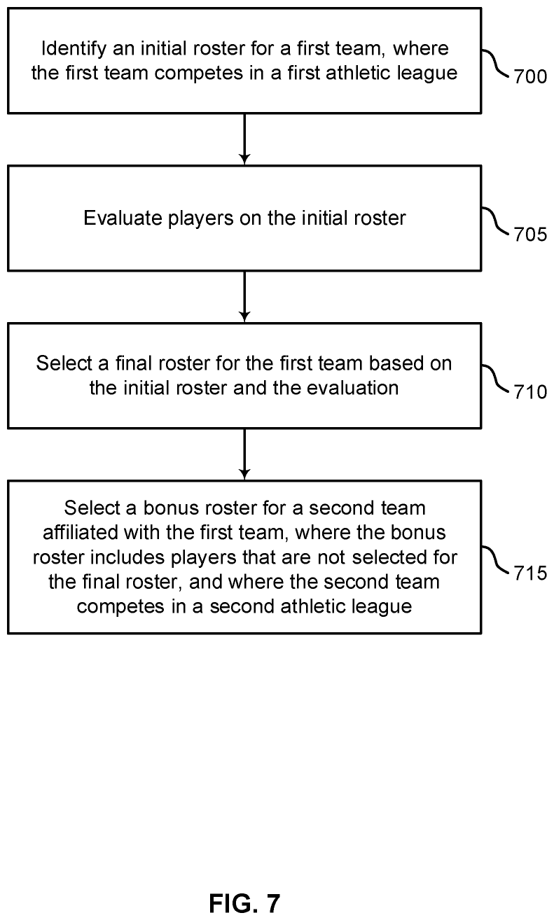

FIG. 7 shows an example of a process for establishing a team roster for a competition league according to aspects of the present disclosure. Generally, these operations may be performed according to the methods and processes described in accordance with aspects of the present disclosure. For example, the operations may be composed of various substeps, or may be performed in conjunction with other operations described herein.

At operation 700, the system identifies an initial roster for a first team, where the first team competes in a first athletic league. In some cases, the operations of this step may refer to, or be performed by, a first team initial roster manager as described with reference to FIG. 6.

At operation 705, the system evaluates players on the initial roster. In some cases, the operations of this step may refer to, or be performed by, a first team player resource manager as described with reference to FIG. 6.

At operation 710, the system selects a final roster for the first team based on the initial roster and the evaluation. In some cases, the operations of this step may refer to, or be performed by, a first team player resource manager as described with reference to FIG. 6.

At operation 715, the system selects a bonus roster for a second team affiliated with the first team, where the bonus roster includes players that are not selected for the final roster, and where the second team competes in a second athletic league. In some cases, the operations of this step may refer to, or be performed by, a second team bonus roster manager as described with reference to FIG. 6.

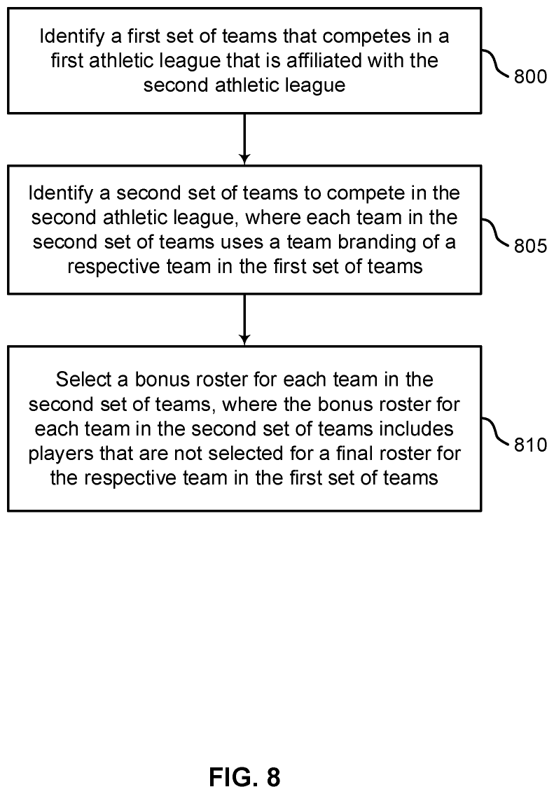

FIG. 8 shows an example of a process for establishing a competition league according to aspects of the present disclosure. Generally, these operations may be performed according to the methods and processes described in accordance with aspects of the present disclosure. For example, the operations may be composed of various substeps, or may be performed in conjunction with other operations described herein.

At operation 800, the system identifies a first set of teams that competes in a first athletic league that is affiliated with the second athletic league. In some cases, the operations of this step may refer to, or be performed by, a league affiliation manager as described with reference to FIG. 6.

At operation 805, the system identifies a second set of teams to compete in the second athletic league, where each team in the second set of teams uses a team branding of a respective team in the first set of teams. In some cases, the operations of this step may refer to, or be performed by, a league affiliation manager as described with reference to FIG. 6.

At operation 810, the system selects a bonus roster for each team in the second set of teams, where the bonus roster for each team in the second set of teams includes players that are not selected for a final roster for the respective team in the first set of teams. In some cases, the operations of this step may refer to, or be performed by, a team affiliation manager as described with reference to FIG. 6.

Accordingly, the present disclosure includes the following embodiments.

A method for establishing a competition league is described. Embodiments of the method may include identifying an initial roster for a first team, wherein the first team competes in a first athletic league, evaluating players on the initial roster, selecting a final roster for the first team based on the initial roster and the evaluation, and selecting a bonus roster for a second team affiliated with the first team, wherein the bonus roster comprises players that are not selected for the final roster, and wherein the second team competes in a second athletic league.

In some examples, the evaluation of each player on the initial roster is performed during a preseason training camp. Some examples of the method described above may further include evaluating players on the bonus roster. Some examples may further include selecting one or more players from the bonus roster for the first team based on evaluation of the players on the bonus roster. In some examples, a first set of game rules for the first athletic league are substantially the same as a second set of game rules for the second athletic league. In some examples, the second set of game rules includes one or more experimental rules selected for evaluation for inclusion in the first set of game rules.

In some examples, the first team is associated with a first team branding that is substantially the same as a second team branding for the second team. In some examples, the second team branding comprises one or more differences from the first team branding that are uniform across teams in the second league. In some examples, the first team employs a first playbook, and the second team employs a second playbook that is based on the first playbook. Some examples of the method described above may further include playing one or more preseason games using the initial roster. In some examples, the initial roster and the final roster are selected based on roster limits enforced by the first athletic league.

A method for establishing a competition league is described. Embodiments of the method may include identifying a first set of teams that competes in a first athletic league that is affiliated with the second athletic league, identifying a second set of teams to compete in the second athletic league, wherein each team in the second set of teams uses a team branding of a respective team in the first set of teams, and selecting a bonus roster for each team in the second set of teams, wherein the bonus roster for each team in the second set of teams comprises players that are not selected for a final roster for the respective team in the first set of teams.

Some examples of the method described above may further include identifying the second set of teams where each team in the second set of teams uses the team branding of the respective team in the first set of teams comprises. Some examples may further include identifying a geographical region associated with a first team in the first set of teams. Some examples may further include identifying a first team branding for the first team in the first set of teams. Some examples may further include identifying a second team in the second set of teams based on the first team branding, wherein a second team branding for the second team is substantially the same as the first team branding based on the second team being associated with the geographical region.

In some examples, the second team branding comprises one or more differences from the first team branding that are the same as team branding differences between each team in the second set of teams and their respective team in the first set of teams.

Some examples of the method described above may further include identifying a second game play schedule for the second athletic league based on a first game play schedule for the first athletic league, wherein the first game play schedule and the second game play schedule align traveling between the first athletic league and the second athletic league, allow sharing of a stadium between the first athletic league and the second athletic league, or both. In some examples, the first athletic league and the second athletic league share a preseason training camp and the bonus roster for each team in the second set of teams is selected after the shared preseason training camp.

Some examples of the method described above may further include identifying a second set of game rules for the second athletic league that are substantially the same as a first set of game rules for the first athletic league. In some examples, the second set of game rules includes one or more experimental rules selected for evaluation for inclusion in the first set of rules. In some examples, each team in the second set of teams employs a first playbook based on a second playbook that is employed by the respective team in the first set of teams. In some examples, a result of a season in the second athletic league impacts access to player resources by the first set of teams in a subsequent season in the first athletic league. In some examples, a final season ranking of each team in the second set of teams impacts a player drafting order of a respective team in the first set of teams.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method of assembling an athletic team, the method comprising:
identify an initial roster for a first team, wherein the first team competes in a first athletic league;
evaluate players on the initial roster;
select a final roster for the first team based on the initial roster and the evaluation; and
select a bonus roster for a second team affiliated with the first team, wherein the bonus roster comprises players that are not selected for the final roster, and wherein the second team competes in a second athletic league.

2. The method of claim 1, wherein:
the evaluation of each player on the initial roster is performed during a preseason training camp.

3. The method of claim 1, further comprising:
evaluate players on the bonus roster; and
select one or more players from the bonus roster for the first team based on evaluation of the players on the bonus roster.

4. The method of claim 1, wherein:
a first set of game rules for the first athletic league are substantially the same as a second set of game rules for the second athletic league.

5. The method of claim 4, wherein:
the second set of game rules includes one or more experimental rules selected for evaluation for inclusion in the first set of game rules.

6. The method of claim 1, wherein:
the first team is associated with a first team branding that is substantially the same as a second team branding for the second team.

7. The method of claim 6, wherein:
the second team branding comprises one or more differences from the first team branding that are uniform across teams in the second league.

8. The method of claim 1, wherein:
the first team employs a first playbook, and the second team employs a second playbook that is based on the first playbook.

9. The method of claim 1, further comprising:
play one or more preseason games using the initial roster.

10. The method of claim 1, wherein:
the initial roster and the final roster are selected based on roster limits enforced by the first athletic league.

11. A method of assembling a second athletic league, the method comprising:
identify a first set of teams that competes in a first athletic league that is affiliated with the second athletic league;
identify a second set of teams to compete in the second athletic league, wherein each team in the second set of teams uses a team branding of a respective team in the first set of teams; and
select a bonus roster for each team in the second set of teams, wherein the bonus roster for each team in the second set of teams comprises players that are not selected for a final roster for the respective team in the first set of teams.

12. The method of claim 11, wherein identifying the second set of teams where each team in the second set of teams uses the team branding of the respective team in the first set of teams comprises:
identify a geographical region associated with a first team in the first set of teams;
identify a first team branding for the first team in the first set of teams; and
identify a second team in the second set of teams based on the first team branding, wherein a second team branding for the second team is substantially the same as the first team branding based on the second team being associated with the geographical region.

13. The method of claim 12, wherein:
the second team branding comprises one or more differences from the first team branding that are the same as team branding differences between each team in the second set of teams and their respective team in the first set of teams.

14. The method of claim 11, further comprising:
identify a second game play schedule for the second athletic league based on a first game play schedule for the first athletic league, wherein the first game play schedule and the second game play schedule align traveling between the first athletic league and the second athletic league, allow sharing of a stadium between the first athletic league and the second athletic league, or both.

15. The method of claim 11, wherein:
the first athletic league and the second athletic league share a preseason training camp and the bonus roster for each team in the second set of teams is selected after the shared preseason training camp.

16. The method of claim 11, further comprising:
identify a second set of game rules for the second athletic league that are substantially the same as a first set of game rules for the first athletic league.

17. The method of claim 16, wherein:
the second set of game rules includes one or more experimental rules selected for evaluation for inclusion in the first set of rules.

18. The method of claim 11, wherein:
each team in the second set of teams employs a first playbook based on a second playbook that is employed by the respective team in the first set of teams.

19. The method of claim 11, wherein:
a result of a season in the second athletic league impacts access to player resources by the first set of teams in a subsequent season in the first athletic league.

20. The method of claim 19, wherein:
a final season ranking of each team in the second set of teams impacts a player drafting order of a respective team in the first set of teams.
